(19) United States
(12) Patent Application Publication
(10) Pub. No.: US 2026/0072975 A1
(43) Pub. Date: Mar. 12, 2026

(54) Machine Learning-Based Techniques for Document Layout Identification and Data Extraction

(71) Applicant: Oracle International Corporation, Redwood Shores, CA (US)

(72) Inventors: Robert Allan Abbe, Chaska, MN (US); Erhan Erdemir, San Francisco, CA (US); Harshavardhan Takle, Foster City, CA (US); Michael Ho-man Tang, Seattle, WA (US)

(73) Assignee: Oracle International Corporation, Redwood Shores, CA (US)

(21) Appl. No.: 19/185,147

(22) Filed: Apr. 21, 2025

Related U.S. Application Data
(60) Provisional application No. 63/691,765, filed on Sep. 6, 2024.

(51) Int. Cl. G06F 16/35; G06V 30/412; G06V 30/413; G06V 30/414

(52) U.S. Cl. CPC G06F 16/35; G06V 30/412; G06V 30/413; G06V 30/414

(57) ABSTRACT

Techniques for identifying a document layout are disclosed. In one embodiment, attribute data associated with an electronic document is accessed. A machine learning model is then applied to the attribute data. The machine learning model is configured to classify the electronic document based on the attribute data and feature sets of a plurality of document classes. Based on the document class predicted by the machine learning model, the system identifies a layout associated with the document class. The layout specifies layout elements and content types associated with the layout elements. The system extracts and stores information from the electronic document according to its content type.

### BENEFIT CLAIMS; RELATED APPLICATIONS; INCORPORATION BY REFERENCE

This application claims the benefit of U.S. Provisional Patent Application 63/691,765, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to document processing. In particular, the present disclosure relates to automated document layout identification and data extraction.

### BACKGROUND

There are many instances in which information needs to be extracted from an electronic document. This can include instances in which a paper document is scanned or photographed and made into an electronic format that substantially alters the original paper document's appearance. Furthermore, there are many instances in which that extraction cannot be automated or is inhibited in some manner. A human operator may be required to facilitate the extraction by defining the information to be extracted.

Optical character recognition (OCR) is a method of processing an image or document to find text within the image or document. OCR converts images of typed, handwritten, or printed text into machine-encoded text. One may desire to take information from the electronic document and convert it into machine-encoded data, so the machine-encoded data can be electronically edited, searched, stored more compactly, displayed on-line, or used in machine processes. Once machine-encoded, data can be converted into a format that is more easily capable of processing, such as a format readable by spreadsheets, accounting programs, and the like.

OCR is widely used for the conversion of text documents (such as books, newspapers, magazines, and the like). OCR extracts text line-by-line from left to right. As a result, conventional OCR techniques work well for extracting data from electronic documents that primarily include text in paragraph forms. The extracted paragraphs can be stored or presented in an intelligible manner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIGS. 2A-2C illustrate an example set of operations for identifying document layouts and extracting document data in accordance with one or more embodiments;

FIGS. 3A and 3B illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DOCUMENT LAY OUT IDENTIFICATION AND DATA EXTRACTION ARCHITECTURE
3. IDENTIFY ING A LAYOUT OF A DOCUMENT TO EXTRACT DATA
4. EXAMPLE EMBODIMENT
5. COMPUTER NETWORKS AND CLOUD NETWORKS
6. HARDWARE OVERVIEW
7. MISCELLANEOUS; EXTENSIONS

### 1. General Overview

One or more embodiments operate a machine learning model to classify electronic documents into distinct document classes and then accurately identify information to extract from those documents. The one or more embodiments can leverage the model's document classifications to automatically extract the identified information from those documents while ensuring a correct recognition of individual words, phrases, characters, and/or values in the extracted information.

The machine learning model may be trained using a training corpus comprising a plurality of documents of different document layouts. One embodiment of the machine learning model defines a document class, for instance, as a unique feature set (i.e., a fingerprint) representing a particular document layout. This is because two different document layouts do not have the same set of feature values and therefore, can be differentiated by comparing feature sets. Examples of such features include static document features, such as logo position, border titles, and consistent layout elements. The unique feature sets may serve as templates for identifying the format used in a matching document for its content, thereby enabling the automatic extraction of the given document's information and the accurate recognition of individual characters/values within that extracted information.

The one or more embodiments apply the machine learning model on an unknown electronic document and by doing so, identify the document's actual layout of content. The application of the machine learning model further results in the determination of specific locations/positions on the unknown document where certain information is presented, thereby enabling the document management system to extract information that would otherwise remain unrecognized. A human operator is not needed to identify locations of any information on the unknown document. In this manner, the one or more embodiments enable automated document processing and data extraction.

The one or more embodiments further include a document management system that operates on behalf of an entity such as a commercial enterprise. The one or more embodiments may configure the document management system to use the machine learning model for automatically extracting information from an unknown electronic document such as an incoming form document from a third-party entity. Thus, the entity operating the document management system benefits from using the machine learning model, for example, to accurately extract various values from supplier invoices. One or more embodiments described in this Specification and/or recited in the claims may not be included in this General Overview section.

### 2. Document Layout Identification and Data Extraction Architecture

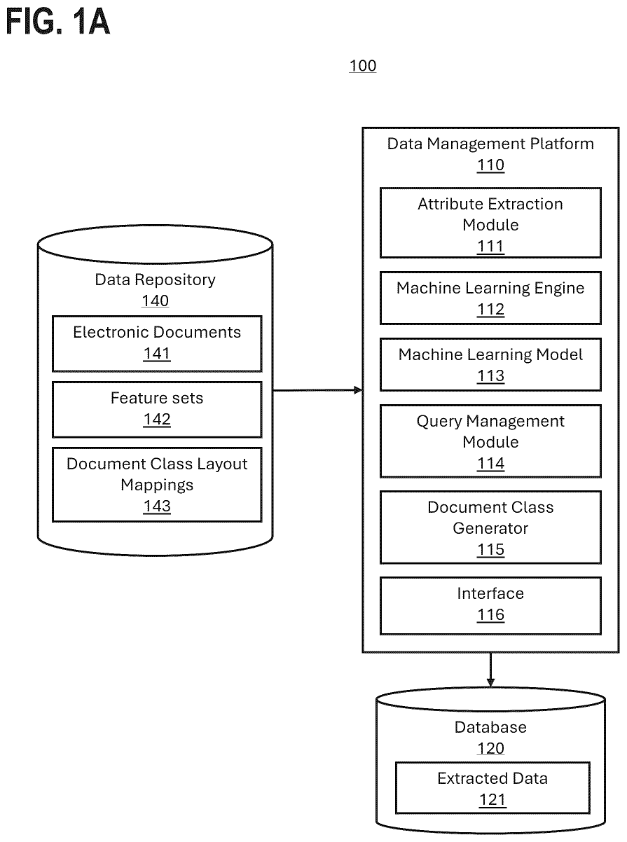

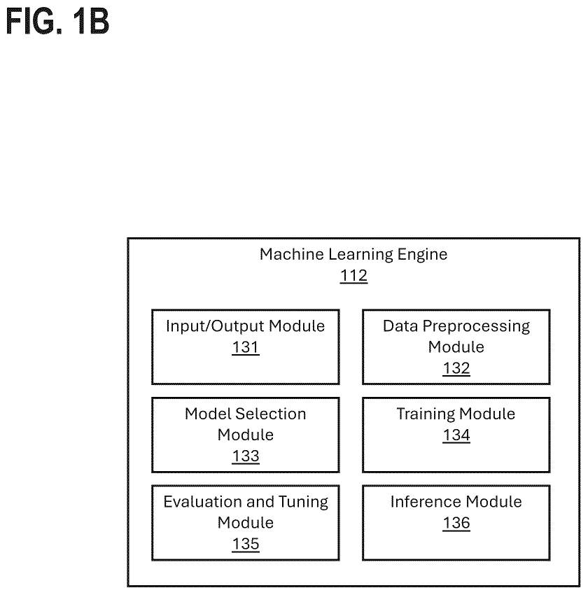

FIG. 1 illustrates a system 100 in accordance with one or more embodiments. A s illustrated in FIG. 1, system 100 includes a data management platform 110, database 120, and data repository 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the data management platform 110. Additionally, or alternatively, a data repository 140 may be implemented or executed on a computing system separate from the data management platform 110. The data repository 140 may be communicatively coupled to the data management platform 110 via a direct connection or via a network.

Information describing electronic documents 141, feature sets 142, and document class layout mappings 143 may be implemented across any of components within the system 100. However, this information is illustrated within the data repository 140 for purposes of clarity and explanation.

An entity, which may be a single user or a large organization, can configure the data management platform 110 for an enterprise consisting of multiple users who continuously add, remove, modify, and/or update datasets in external data sources such as in entity database(s) 120. As such, the data management platform 110 can be communicatively coupled with the entity database(s) 120 and coordinate input/output of data to stored datasets, thereby maintaining data security, integrity, and correctness for the entity. In addition to facilitating user access to the above-mentioned stored datasets, the data management platform 110 automates the intake of electronic documents 141 and the subsequent processing of any document content, including the consolidation of their data with the entity database 120.

The electronic documents 141 generally refers to electronic documents from which various datasets can be extracted, processed, and then stored in the entity database 120. It should be noted that an electronic document can present various content, including form data, non-form data, or both the form data and the non-form data. Each document 141 may be obtained by the data management platform 110 from the data repository 140 or from another source. The document may be received using an electronic transmission, such as email, instant messaging, or short message system. The document 141 can be in any type of electronic format. Common electronic formats include portable document format (“PDF”), JPEG, TIFF, PNG, DOC, and DOCX. The electronic documents 141 may be converted to the electronic format from a non-electronic format. For example, a document may have originally been in paper form. The electronic documents 141 may be converted to an electronic format using a scanner, a camera, or a camcorder. In some embodiments, the document 141 may have been created in an electronic format and received by the system in an electronic format. The documents may include content corresponding to receipts, invoices, income statements, balance sheets, cash flow statements, estimates, and tables.

Some of the electronic documents 141 can be characterized as form documents (also known as online forms). An example of a form document includes form data in the arrangement of a plurality of form fields on which a plurality of datasets may be presented. The example form document also presents at least some information describing the plurality of datasets. In general, a given form field is a portion of the example form document that includes an area for presenting a particular dataset of one or more data values and a descriptor for the particular dataset. The descriptor may be a name for the particular dataset and indicative of the expected type of data value(s) for that dataset.

An attribute extraction module 111 extracts document attributes from the electronic documents 141. Document attributes include textual information and positional information of document contents, such as graphics, images, tables, titles, dates, invoice numbers, headers, text fields, columns, and text boxes. Document attributes may also include metadata, including a source of an electronic document, a type of the electronic document, and a size of the electronic document.

Positional information includes, for example, Cartesian coordinates of corners of bounding boxes associated with document content. Bounding box information includes coordinates identifying a top-most pixel, bottom-most pixel, left-most pixel, and right-most pixel of document content. A bounding box is defined by a set of (x and y) coordinates which represent a box such that the box, if drawn, would enclose the corresponding content (e.g., logo, column, text block, graphic). The (x and y) coordinates of the bounding box are used for determining or representing a position and a distance with respect to a corresponding content. The (x and y) coordinates of the bounding box may be normalized. In an example, normalizing an x-coordinate includes dividing the x-coordinate with a width of the page that includes the x-coordinate. Normalizing a y-coordinate includes dividing the y-coordinate with a height of the page that includes the y-coordinate. The normalized values may then range from 0 to 1. In another example, the x-coordinates and y-coordinates may be divided by a maximum of a page width and a page height, preserving the aspect ratio of the page.

Document attributes include the shape, brightness, angle, and color of document content. In an example set of documents including invoices, positional information includes, for example, identifying document coordinates associated with corners of a table, associated with a border of a logo, associated with corners of a border title, or associated with any other element in the document.

Based on the document attributes extracted from electronic documents 141, the attribute extraction module 111 stores feature sets 142 of the electronic documents. A feature set for one electronic document 141 includes the attributes of the document, including the text, layout, and metadata attributes.

The data management platform 110 includes a machine learning engine 112 for training a classification-type machine learning model to classify electronic documents according to unique feature sets of the electronic documents.

FIG. 1B illustrates an example of a machine learning engine 112 according to one or more embodiments. As illustrated in FIG. 1B, machine learning engine 112 includes input/output module 131, data preprocessing module 132, model selection module 133, training module 134, evaluation and tuning module 135, and inference module 136.

In accordance with an embodiment, input/output module 131 serves as the primary interface for data entering and exiting the system, managing the flow and integrity of data. This module may accommodate a wide range of data sources and formats to facilitate integration and communication within the machine learning architecture.

In an embodiment, an input handler within input/output module 131 includes a data ingestion framework capable of interfacing with various data sources, such as databases, A Pls, file systems, and real-time data streams. This framework is equipped with functionalities to handle different data formats (e.g., CSV, JSON, X machine learning) and efficiently manage large volumes of data. It includes mechanisms for batch and real-time data processing that enable the input/output module 131 to be versatile in different operational contexts, whether processing historical datasets or streaming data.

In accordance with an embodiment, input/output module 131 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 131 includes an output framework designed to handle the distribution and exportation of outputs, predictions, or insights. Using the output framework, input/output module 131 formats these outputs into user-friendly and accessible formats, such as reports, visualizations, or data files compatible with other systems. Input/output module 131 also ensures secure and efficient transmission of these outputs to end-users or other systems in an embodiment and may employ encryption and secure data transfer protocols to maintain data confidentiality.

In accordance with an embodiment, data preprocessing module 132 transforms data into a format suitable for use by other modules in machine learning engine 112. For example, data preprocessing module 132 may transform raw data into a normalized or standardized format suitable for training machine learning models and for processing new data inputs for inference. In an embodiment, data preprocessing module 132 acts as a bridge between the raw data sources and the analytical capabilities of machine learning engine 112.

In an embodiment, data preprocessing module 132 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 132 may be configured to handle anomalies in different ways, depending on context. Data preprocessing module 132 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 132 includes a feature encoding framework that ensures categorical variables are transformed into a format that can be easily interpreted by machine learning algorithms. Techniques, like one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 132 processes new data for inference, data preprocessing module 132 replicates the same preprocessing steps to ensure consistency with the training data format. This helps to avoid discrepancies between the training data format and the inference data format, thereby reducing the likelihood of inaccurate or invalid model predictions.

In an embodiment, model selection module 133 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 133 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 133 utilizes techniques from the field of Automated Machine Learning (Automachine learning). Automachine learning systems automate the process of model selection by rapidly prototyping and evaluating multiple models. They use techniques, like Bayesian optimization, genetic algorithms, or reinforcement learning, to explore the model space efficiently. Model selection module 133 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 133 also considers computational efficiency and resource constraints. This ensures the selected model is both accurate and practical in terms of computational and time requirements. In an embodiment, certain features of model selection module 133 are configurable such as a configured bias toward (or against) computational efficiency.

In accordance with an embodiment, training module 134 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 134 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 134 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 134 includes logic to handle different types of data and learning tasks. For instance, it includes different training routines for supervised learning (where the training data comes with labels) and unsupervised learning (without labeled data). In the case of deep learning models, training module 134 also manages the complexities of training neural networks that include initializing network weights, choosing activation functions, and setting up neural network layers.

In an embodiment, evaluation and tuning module 135 incorporates dynamic feedback mechanisms and facilitates continuous model evolution to help ensure the system's relevance and accuracy as the data landscape changes. Evaluation and tuning module 135 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 135 performs continuous model tuning by using hyperparameter optimization. Evaluation and tuning module 135 performs an exploration of the hyperparameter space using algorithms, such as grid search, random search, or more sophisticated methods like Bayesian optimization. Evaluation and tuning module 135 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 135 integrates data feedback and updates the model. Evaluation and tuning module 135 actively collects feedback from the model's real-world applications, an indicator of the model's performance in practical scenarios. Such feedback can come from various sources, depending on the nature of the application. For example, in a user-centric application, such as a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 135 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 135 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 136 transforms data raw data into actionable, precise, and contextually relevant predictions. In addition to processing and applying a trained model to new data, inference module 136 may also include post-processing logic that refines the raw outputs of the model into meaningful insights.

In an embodiment, inference module 136 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 136 transforms the outputs of a trained model into definitive classifications. Inference module 136 employs the underlying model as a tool to generate probabilistic outputs for each potential class. It then engages in an interpretative process to convert these probabilities into concrete class labels.

In an embodiment, when inference module 136 receives the probabilistic outputs from the model, it analyzes these probabilities to determine how they are distributed across some, or every, potential class. If the highest probability is not significantly greater than the others, inference module 136 may determine that there is ambiguity or interpret this as a lack of confidence displayed by the model.

In an embodiment, inference module 136 uses thresholding techniques for applications where making a definitive decision based on the highest probability might not suffice due to the critical nature of the decision. In such cases, inference module 136 assesses if the highest probability surpasses a certain confidence threshold that is predetermined based on the specific requirements of the application. If the probabilities do not meet this threshold, inference module 136 may flag the result as uncertain or defer the decision to a human expert. Inference module 136 dynamically adjusts the decision thresholds based on the sensitivity and specificity requirements of the application subject to calibration for balancing the trade-offs between false positives and false negatives.

In accordance with an embodiment, inference module 136 contextualizes the probability distribution against the backdrop of the specific application. This involves a comparative analysis, especially in instances where multiple classes have similar probability scores, to deduce the most plausible classification. In an embodiment, inference module 136 may incorporate additional decision-making rules or contextual information to guide this analysis, ensuring that the classification aligns with the practical and contextual nuances of the application.

In regression models, where the outputs are continuous values, inference module 136 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 136 incorporates domain-specific adjustments into its post-processing routine. This involves tailoring the model's output to align with specific industry knowledge or contextual information. For example, in financial forecasting, inference module 136 may adjust predictions based on current market trends, economic indicators, or recent significant events, ensuring that the outputs are both statistically accurate and practically relevant.

In an embodiment, inference module 136 includes logic to handle uncertainty and ambiguity in the model's predictions. In cases where inference module 136 outputs a measure of uncertainty, such as in Bayesian inference models, inference module 136 interprets these uncertainty measures by converting probabilistic distributions or confidence intervals into a format that can be easily understood and acted upon. This provides users with both a prediction and an insight into the confidence level of that prediction. In an embodiment, inference module 136 includes mechanisms for involving human oversight or integrating the instance into a feedback loop for subsequent analysis and model refinement.

In an embodiment, inference module 136 formats the final predictions for end-user consumption. Predictions are converted into visualizations, user-friendly reports, or interactive interfaces. In some systems, like recommendation engines, inference module 136 also integrates feedback mechanisms, where user responses to the predictions are used to continually refine and improve the model, creating a dynamic, self-improving system.

In an embodiment, input/output module 131 receives a dataset intended for training. This data can originate from diverse sources, like databases or real-time data streams, and in varied formats, such as CSV, JSON, or X machine learning. Input/output module 131 assesses and validates the data, ensuring its integrity by checking for consistency, data ranges, and types.

In an embodiment, training data is passed to data preprocessing module 132. Here, the data undergoes a series of transformations to standardize and clean it, making it suitable for training machine learning models. This involves normalizing numerical data, encoding categorical variables, and handling missing values through techniques like imputation.

In an embodiment, prepared data from the data preprocessing module 132 is then fed into model selection module 133. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 134 trains the selected model with the prepared dataset. It implements learning algorithms to adjust the model's internal parameters, optimizing them to identify patterns and relationships in the training data. Training module 134 also addresses the challenge of overfitting by implementing techniques, like regularization and early stopping, ensuring the model's generalizability.

According to an example embodiment, machine learning model 113 includes a neural network. For example, machine learning model 113 may be implemented as deep-learning neural networks. The training module 134 applies a machine learning algorithm to a training data set to the machine learning model 113. For example, the machine learning algorithm may analyze the training data set to train neurons of a neural network with particular weights and offsets to associate particular electronic document feature sets with particular document classifications or classes.

In some embodiments, the training module 134 iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the training module 134 may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one feature may depend on its position within a sequence of feature vector representations. Thus, the nodes may have a memory to remember relevant temporal dependencies between different sets of input features.

In some embodiments, the training module 134 compares the labels estimated through the one or more iterations of the machine learning model algorithm with observed labels to determine an estimation error. The training module 134 may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the training module 134 determines whether to adjust the weights and/or other model parameters based on the estimation error. Adjustments may be made until a candidate model that minimizes the estimation error or otherwise achieves a threshold level of estimation error is identified. In some embodiments, the training module 134 selects machine learning model parameters based on the estimation error meeting a threshold accuracy level. For example, the system may select a set of parameter values for a machine learning model based on determining that the trained model has an accuracy level for predicting labels of at least 98%.

In an embodiment, evaluation and tuning module 135 evaluates the trained model's performance using the validation dataset. Evaluation and tuning module 135 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 131 receives a dataset intended for inference. Input/output module 131 assesses and validates the data.

In an embodiment, data preprocessing module 132 receives the validated dataset intended for inference. Data preprocessing module 132 ensures that the data format used in training is replicated for the new inference data, maintaining consistency and accuracy for the model's predictions.

In an embodiment, inference module 136 processes the new data set intended for inference, using the trained and tuned model. It applies the model to this data, generating raw probabilistic outputs for predictions. Inference module 136 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In one or more embodiments, the training module 134 applies a machine learning algorithm to train the machine learning model 113. The machine learning algorithm is an algorithm that can be iterated to train a target model f that best maps a set of input variables to an output variable. One example machine learning algorithm is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model fand accuracy of the current target model f. Updated training data is fed back into the machine learning algorithm, which in turn updates the target model f.

The example machine learning algorithm generates a target model f such that the target model f best fits the datasets of training data to the labels of the training data. Additionally, or alternatively, the example machine learning algorithm generates a target model f such that when the target model f is applied to the datasets of the training data, a maximum number of results determined by the target model f matches the labels of the training data. Different target models be generated based on different machine learning algorithms and/or different sets of training data.

The example machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In one embodiment, the machine learning model 113 is a neural network. The neural network includes sets of interconnected nodes, or neurons. The neurons are organized into several layers: an input layer that receives a vector representing a document feature set, a set of hidden layers, and an output layer that generates an output representing a document classification. The neurons of the neural network store a function. The function includes variables. The machine learning algorithm provides input values to the variables from (a) an input vector representing document feature sets for the input layer and (b) a previous layer of the neural network for the hidden layers and the output layer. The function includes, for each variable, a weight value. The training module 134 adjusts the weight values during training of the machine learning model 113. The training module 134 adjusts the weight values during training based on a strength of a correlation of an input value on the output of the neuron. Assigning a greater weight to an input value from a neuron of a preceding layer represents a stronger correlation with a neuron of a successive layer than assigning a lower weight to the input value from the neuron of the preceding layer. The weight values are fixed in the trained machine learning model 113. The function sums the variable/weight pairs. The function applies a bias value to the sum. The function passes the biased sum value to an activation function. The activation function generates an output value that is passed (a) to a next layer as an input value for the input layer and hidden layers and (b) as a document classification value for the output layer.

An example of a neural function is provided below, where z represents a weighted sum, w represents a weight value, x represents an input value from (a) an input vector or (b) a previous layer of the neural network, and b represents a bias value:

z=w₁x₁+w₂x₂+ . . . +wₙxₙ+b=w·x+b.

The neurons output a neuron output value according to the activation function. For example, an activation function may generate a binary output of 0 or 1. As another example, an activation function may generate a value along a gradient between 0 and 1, such as 0, 0.10, 0.11, 0.25, etc.

In one or more embodiments, each neuron of one layer is connected to each neuron of a next layer. In some embodiments, the machine learning engine 112 prunes the machine learning model 113 after training the model 113 by (a) setting neural weights to zero for neurons that have little weight on a document classification and/or (b) omitting from the neural network particular neurons that have little effect on the document classification.

The machine learning model 113 may be stored as a software artifact or as software code in memory.

The data management platform 110 stores document class layout mappings 143 for the electronic documents 141. The mappings 143 specify portions of the electronic document classes that correspond to particular content types. For example, a mapping of an invoice from a service provider may specify portions of the a particular invoice class that correspond to (a) provider data such as a provider address, (b) a logo, (c) header information, (d) a table of services provided and costs associated with the services, and (e) the portion of the table associated with service descriptions and the portion associated with the costs. As another example, a mapping for a particular fillable form class may identify (a) portions of the form that are not editable, (b) portions of the form that are editable, and (c) content types associated with the portions of the form that are editable. The document class layout mapping 143 may specify one set of data as corresponding to one data type and another set of data as corresponding to another data type. For example, one set of fillable data may correspond to a user's name, another to a user's address, another to a spouse's name, another to a dependent's name, another to a user's phone number, another to an emergency content phone number, etc.

A query management module 114 manages queries to a database 120. The database 120 stores extracted data 121. The extracted data 121 includes data extracted from the electronic documents 141. The extracted data 121 may be stored in tables according to the document class layout mappings 143. For example, a database table may store name data, product data, address data, and unique identifier data from a first set of fields across different document classes. A n “Invoice” table may store product/service and price data extracted from a set of invoices of the same document class or from different document classes that correspond to different classes of invoices.

The database 120 includes data and metadata stored on one or more memory devices such as on a set of hard disks. The database 120 stores the data and metadata according to a particular structure. According to one example, the database 120 stores data and metadata as a relational database construct. According to another example, the database 120 stores the data and metadata as an object-oriented database construct. In an embodiment in which the database 120 stores data in an object-oriented structure, one data structure is referred to as an object class, records are referred to as objects, and fields are referred to as attributes. In an embodiment in which the database 120 is a relational-type database, one data structure is referred to as a table, records are referred to as rows of the tables, and fields are referred to as columns. While examples of database structures and languages are provided for purposes of description, embodiments are not limited to any single type of database structure or language.

In an embodiment, the query management module 114 includes a database server. The database server includes a query parser and a query optimizer. The query parser receives a query statement from an application and generates an internal query representation of the query statement. According to an embodiment, the internal query representation represents different components and structures of a query statement. For example, the internal query representation may be represented as a graph of nodes. The internal representation is typically generated in memory for evaluation, manipulation, and transformation by a query optimizer.

The query optimizer evaluates the internal query representation to generate a set of candidate execution plans for a executing a query or set of queries. Execution plans specify an order in which execution plan operations are performed and how data flows between each of the execution plan operations. Execution plan operations include, for example, a table scan, an index scan, hash-join, sort-merge join, nested-loop join, and filter.

A document class generator 115 identifies and generates records associated with document classes. For example, a machine learning model 113 may receive a document of an unknown class. The machine learning model 113 may predict that the document does not correspond to a known class. The document class generator 115 may generate a new class for the document. In one or more embodiments, a user may interact with the document class generator 115 to identify the new document class. In one or more embodiments, the machine learning engine 112 retrains the machine learning model 113 based on the new document class.

In one or more embodiments, interface 116 refers to hardware and/or software configured to facilitate communications between a user and the data management platform 110. Interface 116 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 116 are specified in different languages. The behavior of user interface elements is specified in a dynamic programming language such as JavaScript. The content of user interface elements is specified in a markup language, such as hypertext markup language (HT machine learning) or X machine learning U ser Interface Language (XUL). The layout of user interface elements is specified in a style sheet language such as Cascading Style Sheets (CSS). Alternatively, interface 116 is specified in one or more other languages, such as Java, C, or C++.

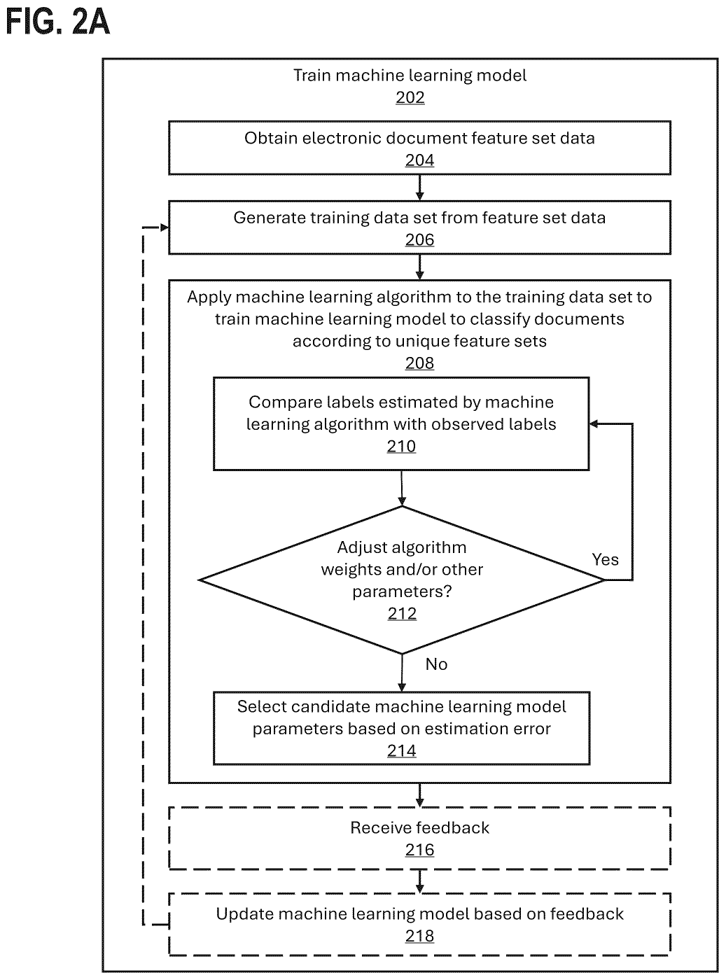

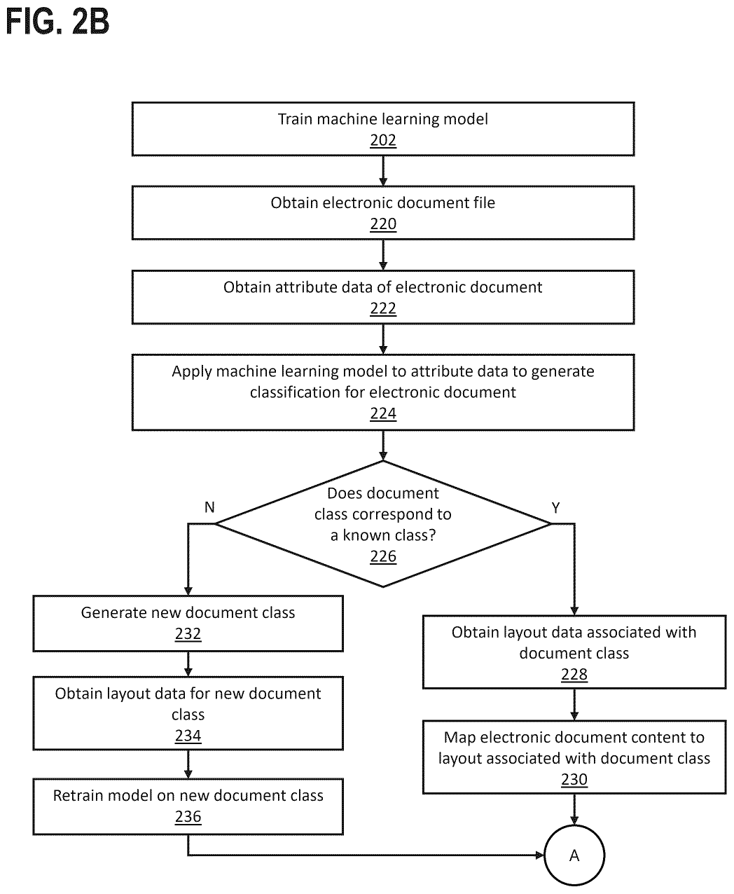

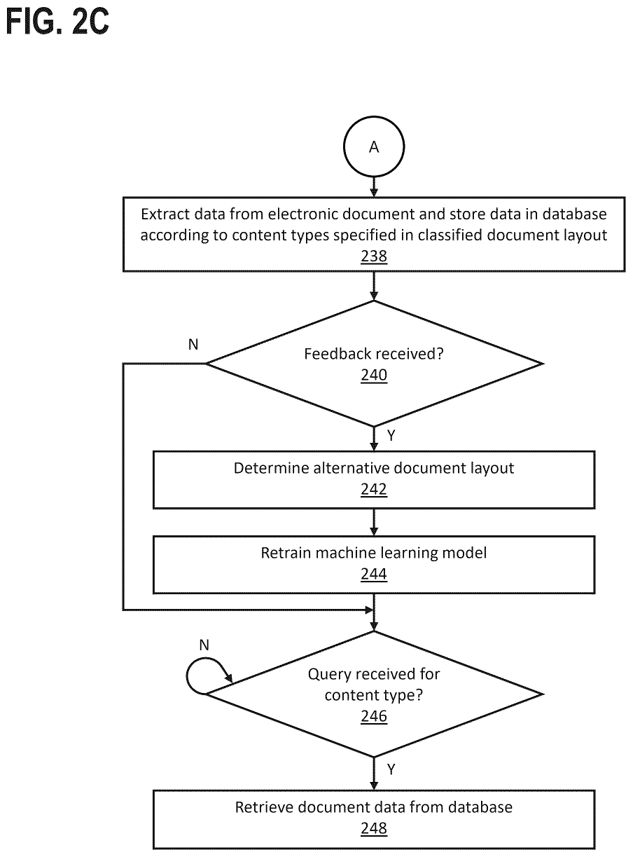

In one or more embodiments, the data management platform refers to hardware and/or software configured to perform operations described herein for classifying electronic documents and extracting data according to the classifications. Examples of operations for classifying electronic documents and extracting data according to the classifications are described below with reference to FIGS. 2A-2C.

In an embodiment, the data management platform is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, a web server, a network policy server, and a proxy server.

### 3. Identifying a Layout of a Document to Extract Data

FIGS. 2A-2C illustrate an example set of operations for identifying document layouts and extracting document data in accordance with one or more embodiments. One or more operations illustrated in FIGS. 2A-2C may be modified, rearranged, or omitted. Accordingly, the particular sequence of operations illustrated in FIGS. 2A-2C should not be construed as limiting the scope of one or more embodiments.

In an embodiment, a system trains a machine learning model (Operation 202). The machine learning model may be, for example, a neural network.

In some embodiments, a system (e.g., one or more components of system 100 illustrated in FIG. 1) obtains electronic document feature set data (Operation 204). Obtaining the electronic document feature set data may include applying OCR applications to digital files representing documents. The system may parse the digital files to identify content and layout features of the electronic documents. Examples of feature set data include logo positions, logo content, logo shape, and logo color, title data, and locations of content within the document, such as a location and shape of text content, image content, and graphics content. In some embodiments, the feature set data includes relationship data among elements in the electronic documents. For example, the feature set data may include a Euclidian distance between a portion of one text field and another, between one graphic and another, and between text fields and image or graphics content.

For instance, knowing that a particular supplier's invoice includes a particular document layout allows the system to accurately extract attribute data from those lines. The first four lines of the particular supplier's invoice may include header information, such as a billing entity and a bill-to entity, and map to known phrases, such as “Invoice Number”, “Total Cost”, and “three-legged blue stool.” The system may further determine based on the particular document layout that any table included subsequent to the header information has a particular format. The particular format of each table may include, for example, one or more header rows with only alphabetical characters followed by line item rows, which include both alphabetical characters and numerical characters. Digits within a text line generally indicate that the text line corresponds to a line item, and those digits may represent a quantity or a price. Known phrases with the text line of the table with at least partially overlapping vertical positions include Item No., Description, Qty, Unit Cost (or Unit Price), and Total. The particular document layout may also specify additional fields within the particular supplier's invoice, such as Sub-Total, Customer Name, Customer Mailing Address, Customer Email Address, and Customer Phone Number.

The system uses the electronic document feature set data to generate a set of training data (Operation 206). The set of training data includes, for an electronic document record, at least one classification label. For example, the system identifies a feature set of a particular electronic document. The system further identifies a document class that corresponds to the feature set.

In some embodiments, generating the training data set includes generating a set of feature vectors for the labeled examples. A feature vector for an example may be n-dimensional, where n represents the number of features in the vector. The number of features that are selected may vary depending on the particular implementation. The features may be curated in a supervised approach or automatically selected from extracted attributes during model training and/or tuning. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if an invoice may originate from one of ten different service providers, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 208). For example, the machine learning algorithm may analyze the training data set to train neurons of a neural network with particular weights and offsets to associate particular feature sets of electronic documents with particular labels.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the system may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one expense or activity may depend on its position within a sequence of feature vector representations. Thus, the nodes may have a memory to remember relevant temporal dependencies between different electronic documents. As another example, one or more nodes may apply different weights if an electronic document is unique or a duplicate of another electronic document on the same day. In this case, the trained machine learning model may automatically filter out and reject duplicate electronic documents such as invoices. Additionally, or alternatively, the system may generate and train other candidate models, such as support vector machines, decision trees, and Bayes classifiers, as previously described.

In some embodiments, the system compares the labels estimated through the one or more iterations of the machine learning model algorithm with observed labels to determine an estimation error (Operation 210). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error (Operation 212). Adjustments may be made until a candidate model that minimizes the estimation error or otherwise achieves a threshold level of estimation error is identified. The process may return to Operation 210 to make adjustments and continue training the machine learning model.

In some embodiments, the system selects machine learning model parameters based on the estimation error meeting a threshold accuracy level (Operation 214). For example, the system may select a set of parameter values for a machine learning model based on determining that the trained model has an accuracy level for predicting labels for electronic document classes of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of related electronic documents. Each electronic document may be processed as a separate discrete instance of time. For instance, an example may include electronic documents c1, c2, and c3 corresponding to times t, t+1, and t+2, respectively. Backpropagation through time may perform adjustments through gradient descent starting at time t+2 and moving backward in time to t+1 and then to t. Furthermore, the backpropagation process may adjust the memory parameters of a cell such that a cell remembers contributions from previous expenses in the sequence of expenses. For example, a cell computing a contribution for e3 may have a memory of the contribution of e2, which has a memory of e1. The memory may serve as a feedback connection such that the output of a cell at one time (e.g., t) is used as an input to the next time in the sequence (e.g., t+1). The gradient descent techniques may account for these feedback connections such that the contribution of one electronic document to a cell's output may affect the contribution of the next electronic document in the cell's output. Thus, the contribution of c1 may affect the contribution of c2, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of electronic documents.

In embodiments in which the machine learning algorithm is a supervised machine learning algorithm, the system may optionally receive feedback on the various aspects of the analysis described above (Operation 216). For example, the feedback may affirm or revise labels generated by the machine learning model. The machine learning model may indicate that a particular electronic document is associated with a label specifying a first document class. The system may receive feedback indicating that the particular electronic document should instead be associated with a label specifying a second document class. Based on the feedback, the machine learning training set may be updated, thereby improving its analytical accuracy (Operation 218). Once updated, the system may further train the machine learning model by optionally applying the model to additional training data sets.

Referring to FIG. 2B, upon training the machine learning model, the system obtains a digital electronic document file (Operation 220). The digital electronic document file is of an unknown document class. In other words, the system may know only that it has received a digital file. The system may not have processed the file to identify the contents of the file or to identify the type or class of the file. Likewise, the layout and content types stored in the electronic document file may be unknown to the system.

The system obtains attribute data of the electronic document (Operation 222). Initially, the system invokes OCR to extract the attribute data. In addition to textual and numerical data, the attribute data may refer to one or more characteristics of the electronic document, such as the coordinate locations for specific document portions, such as specific form fields of a form document. For instance, an attribute for any given form field may be the form data and the position(s) corresponding to the form data.

The system applies the classification machine learning model to the attribute data to generate a classification for the electronic document (Operation 224). As explained herein, the classified electronic document and the particular document class can share similar or matching features, including a logo position, border titles, and other consistent layout elements such as those described herein. The system can determine that the electronic document has the matching feature set with the particular document class based on a pair-wise comparison with corresponding feature values and/or a vector similarity with the particular document class's feature set.

In one or more embodiments, the application of the machine learning model to the attribute data results in identifying document classes that may not be identified by merely comparing attributes against a set of rules. For example, a goods/services table of an invoice may extend onto a second page. In one document class, the second page includes a header portion. In another document class, the second page does not include a header portion. The different document classes are associated with different layout characteristics. Merely applying a set of rules (e.g., the presence or absence of the header) may result in mischaracterizing analyzed documents and mis-categorizing extracted data. However, the machine learning model may learn, via training, the distinguishing features of the respective document classes.

According to another example, a machine learning model may learn, via training, that certain portions of text in an electronic document correspond to fillable text fields. The model may generate document classifications based on the positions of the text fields relative to other text in the electronic document.

The system determines, based on the classification generated by the machine learning model, if the document class corresponds to a known class (Operation 226). For example, the machine learning model may include a set of output values corresponding to a set of known document classes. The machine learning model may include at least one output value that corresponds to an “unknown class.”

If the classification corresponds to a known document class, the system obtains layout data associated with the document class (Operation 228). The layout data specifies types of content and locations where the content types are located in the document. For example, the machine learning model may classify a first document of a type unknown to the system upon ingestion by the system as a first document class corresponding to a type of invoice. Based on the classification, the system determines a first layout, including locations for a company name, services names, and prices in the document. The machine learning model may classify a second document as a second class corresponding to a user information survey, where the document type is unknown to the system upon ingestion by the system. Based on the classification by the machine learning model, the system determines a second layout for the second document, including locations for a document name and data fields associated with names, descriptions, and numerical values.

The system maps electronic document content to the layout associated with the document class (Operation 230). For example, one layout may specify one location for a company name. Another layout may specify another location for the company name. Different layouts may specify different locations for different types of data, including individual and company names, addresses, account numbers, invoice numbers, tables, product codes, monetary values, descriptions of a user's characteristics (e.g., height, weight, age, nationality, etc.), a description of symptoms (e.g., personal health or symptoms in a system, such as a vehicle or computer system), or a description of a user experience (e.g., in a user survey).

If the classification corresponds to an “unknown class,” the system generates a new document class (Operation 232). The system may prompt a user to generate a name or identifier for the new document class. For example, a user may identify the class as “Invoice from Company ABC.” Additionally, or alternatively, the system may generate a name or identifier for the new document class based on contextual data in the electronic document. For example, the system may analyze a document header and/or title to identify a type of document (e.g., Invoice, Statement, Survey, Work Order, etc.).

The system obtains layout data for the new document class (Operation 234). The layout data may be based on the attribute data of the electronic document. The system identifies a feature set that characterizes the new document class. The feature set specifies characteristics and values of the document attributes. For example, the feature set may specify locations of shapes, fields, logos, graphics, titles, and margins in the electronic document. A user may provide additional feedback to identify and/or modify system-generated layout data and feature set data.

The system retrains the model on the new document class (Operation 236). The system may generate a set of synthetic training records based on the feature set associated with the new document class. The feature set includes layout characteristics of the document. The system may generate synthetic values for fields in the document. The system generates a number of synthetic training records to ensure the machine learning model may be trained on the feature set corresponding to the new document class.

In an example embodiment, the system modifies the structure of a neural network to add at least one new output neuron to an output layer of the neural network, where an output value generated by the output neuron represents the new document class. The system stores the retrained model with the at least one additional neuron in the output layer of the neural network.

The system extracts data from the electronic document and stores the data in a database according to the content types specified in the document layout corresponding to the document classification (Operation 238). The system refers to the document layout associated with the document class to determine (a) what data to extract from the document and (b) how to store the data. For example, a database may include a set of relational tables “Supplier,” “Recipient,” and “Invoices.” The system may refer to a layout for a document class to identify a set of fields associated with a supplier. The system may store the data for a supplier in one or both of the Supplier table and the Invoices table. Additionally, or alternatively, the system may generate a pointer in a field of the Invoices table that points to a field in the Supplier table.

To facilitate automation of the above-described data extraction, the system may incorporate the machine learning model into a workflow. A document workflow is a process of managing the way documents are ingested into an enterprise's data management platform and are used within the data management platform. By applying the machine learning model to document data, the document workflow is no longer inhibited by differences in document layouts for documents that are ingested by, and accessed by, a system. Various embodiments enhance these workflows by identifying the correct document layout and determining which specific document portions of electronic documents include specific datasets of values. Such a workflow reduces any need for human intervention to analyze and access data in documents with varying document layouts.

To illustrate by way of an example workflow, the system can be continuously fed incoming supplier invoices while automatically extracting, processing, and then storing the supplier data in the entity's database(s). The example workflow may further program the system to leverage the unique feature sets of the model's document classes as templates for identifying a specific format of the supplier's invoice. The example workflow may be configured to facilitate user access to any extracted invoice data stored in the entity database.

In an embodiment, the system determines if any feedback regarding the extracted information has been received (Operation 240). Through adaptive learning, the system allows for manual review and correction of the extracted information, including any form fields, thereby enriching the machine learning model with newly recognized positions and characteristics. This enriched model is then applied to future documents of the same layout (e.g., supplier invoices of the same format), thereby ensuring consistently accurate data extraction tailored to each document source's style.

In one or more embodiments, the feedback includes the system detecting an anomaly in extracted data. For example, the system may compare data extracted for an electronic document with expected data that is expected based on the document class. The layout associated with the document class may specify a particular content type associated with a layout element in the document. If the system determines the extracted data does not match the expected data, the system may generate a prompt for a user to review the document. A user may determine if (a) the document classification is correct and (b) the correct data was entered into the document. For example, the system may determine that the classification was correct, and a user or system entered incorrect data into the document.

Alternatively, the system may determine the extracted data is correct, and the predicted document class is incorrect. Additionally, or alternatively, the system may determine the extracted data is correct, and the layout and/or mapping of layout elements to content types is incorrect.

If the system determines that feedback was received, the system identifies an alternative document layout associated with the electronic document (Operation 242). A user may provide feedback to correct the extracted information and/or change the first document layout, thereby prompting the system to update a corresponding feature set.

For instance, upon viewing the electronic document, the user may enter feedback in the form of new data for the extracted information and/or a new location attribute for the extracted information. By doing so, the system automatically generates a new feature set to account for the new data and/or the new location attribute. The system may remove some features or add new features in addition to updating feature values for the new feature set.

If the system determines the document corresponds to a different document class than the document class predicted by the machine learning model, the system retrains the machine learning model (Operation 244). The system updates a training data set for the machine learning model to include a sample of records that correspond to the new document class.

The system determines if a query is received corresponding to a particular content type (Operation 246). For example, a database server may receive a request to generate a query to a database where document data is stored.

If the system determines a query is received, the system retrieves document data of the type specified in the query (Operation 248). The system accesses different tables and data objects where different content types are stored, where the different content types are specified in different document layouts.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

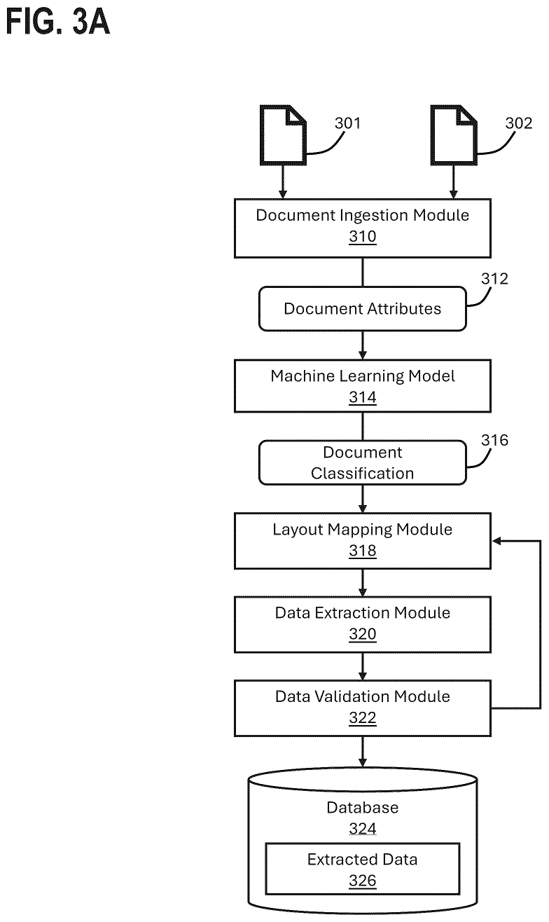

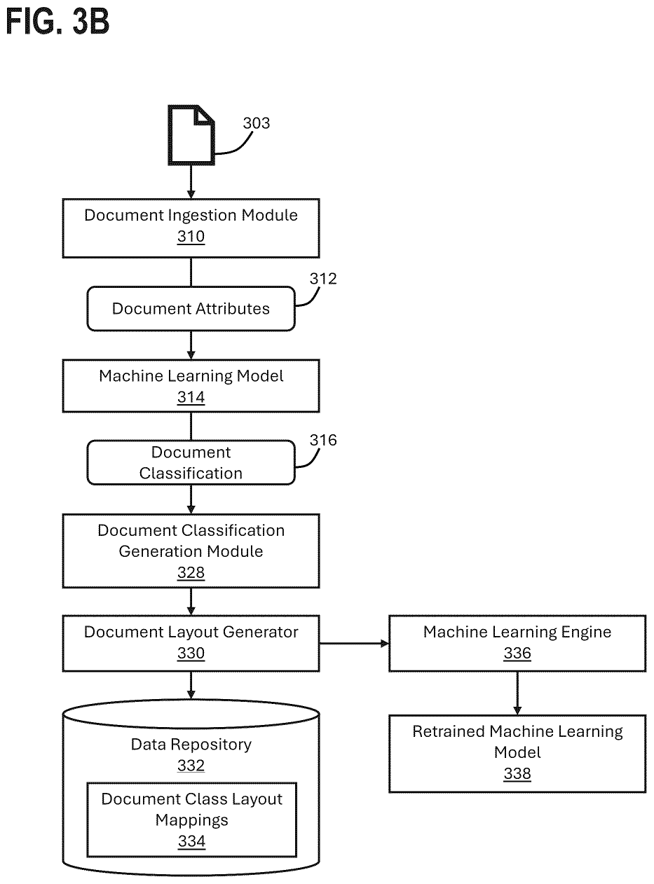

Referring to FIG. 3A, a system provides a document 301 of an unknown type to a document ingestion module 310. The document ingestion module 310 parses the document 301 to generate a set of document attributes 312. The document attributes 312 include position information associated with document content, including text data, image data, graphics data, and layout data. The document ingestion module 310 generates document attributes 312, indicating the document includes logo content at one location, header content identifying an entity and address, and a table. The document attributes 312 specify positional relationships among the content. For example, the document attributes specify coordinates describing a position of a logo, a bounding box around a header, and a position of a table. The document attributes 312 specify characteristics of the content, including a size of the logo, header, and table, a color of the logo. The document attributes 312 may specify words, values, and an invoice number included in the document 301.

A machine learning model receives the document attributes 312 as input data. In particular, the system converts raw attribute data into an input vector of n features. Words and alphanumeric values are converted to numerical values.

The machine learning model 314 generates a document classification 316. The machine learning model 314 classifies the document 301 as an invoice of a class Invoice Type A. A layout mapping module 318 identifies a layout for documents of the class Invoice Type A. The layout specifies fields and layout elements that correspond to a vendor name and address, a logo, an invoice number, and a table of services and corresponding charges.

A data extraction module 320 extracts data from the electronic document 301 to be stored in the database 324. The data validation module 322 validates the data to ensure the data is of a type specified in the document layout corresponding to the document class Invoice Type A. Based on determining the extracted data 326 corresponds to the expected content types (e.g., vendor name, address, logo, invoice number, description of service, cost, image, graphic), the data validation module 322 stores the extracted data 326 in the database 324. The extracted data 326 is stored in tables and fields that correspond to the extracted content type. For example, an Invoices table includes fields for vendors, invoice numbers, and costs.

As another example, the system repeats the process of extracting attributes and generating a document classification 316 for a document 302 of an unknown type. The machine learning model generates a classification of Invoice Type A for document 302. The data extraction module 320 extracts document data based on the mapping. However, the data validation module 322 determines that the extracted data does not match the expected data that is specified in the document class mapping. Instead of a description of a service, the table may include a term “credit” associated with a monetary value.

The system updates the layout mapping module 318 to add the content type “credits” to a set of content types mapped to the table layout feature associated with the Invoice Type A document classification. The system may modify the document mapping automatically, or the system may generate a notification for a user to confirm or modify the recommendation to modify the document mapping.

While FIG. 3A describes an embodiment where a system updates a document layout mapping document elements to content types based on identifying an anomaly in extracted data, a system may alternatively generate a new document type. For example, the document 302 may be a statement that specifies a set of invoice numbers, a set of values associated with the invoice numbers, and a set of credits representing payments. The format of the document may be similar to Invoice Type A, with a logo, header, vendor information, and a table. Based on determining the extracted data (e.g., invoice numbers) does not match data expected based on the document layout mapping (e.g., product description), the system may generate a new document class, Vendor Statement A. The system may generate a layout mapping for the document type that specifies content types Invoice Numbers and Credits in a portion corresponding to a table in the document. The system may retrain the machine learning model on a modified dataset that includes documents of the document class Vendor Statement A.

FIG. 3B illustrates an example of generating a new document class and retraining a machine learning model based on the new document class. Similar to FIG. 3A, a system provides a document 303 to a document ingestion module 310. The document ingestion module 310 parses the document to generate a set of document attributes 312. The system inputs a vector that includes numerical representations of the document attributes 312 to the machine learning model 314. The machine learning model 314 generates a document classification 316. In the embodiment of FIG. 3B, the classification is “Classification Unknown.” A document classification generation module 328 generates a new document classification based on the document attributes. In one embodiment, the system presents one or both of an image of the document and a description of document attributes to a user. The user may generate a name for the new document classification. In the example embodiment of FIG. 3B, the document class is a Vendor Survey Type A class.

A document layout generator 330 generates a layout for the new document class. The document layout includes a title region, question fields, and answer fields. A document layout mapping specifies types of data expected in the answer fields, such as text content, numerical content, and binary values. For example, a survey may include a “Yes” box and a “No” box. The document layout may specify an expected values of “x”, a checkmark, or a filled-in box for the Yes/No boxes. The document layout may specify that the “x,” the “checkmark,” and the filled-in box should be recorded in a database as a binary “1” or “0.”

The document layout generator 330 stores the document class layout mapping in a data repository 332 with other document class layout mappings 334. The document class layout mappings 334 specify document layout elements, relationships between document layout elements, and content types associated with the document layout elements.

A machine learning engine 336 generates a set of training records based on the new document class. The machine learning engine 336 may generate a number of synthetic training records sufficient to train a machine learning model to learn features of the document class. For example, the machine learning engine 336 may generate 10,000 synthetic records that have the format specified in the document layout for the Vendor Survey Type A class and content types corresponding to those specified in a mapping of layout element to content types.

The machine learning engine 336 retrains the machine learning model 338 with a modified dataset, including records representing previously known document classes and the new document class. The system applies attributes of subsequently received documents of unknown classes to the retrained machine learning model 338 to generate document classifications for the documents.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAS, or NPUs with custom programming to accomplish the techniques. The special-purpose computing devices may be desktop computer systems, portable computer systems, handheld devices, networking devices or any other device that incorporates hard-wired and/or program logic to implement the techniques.

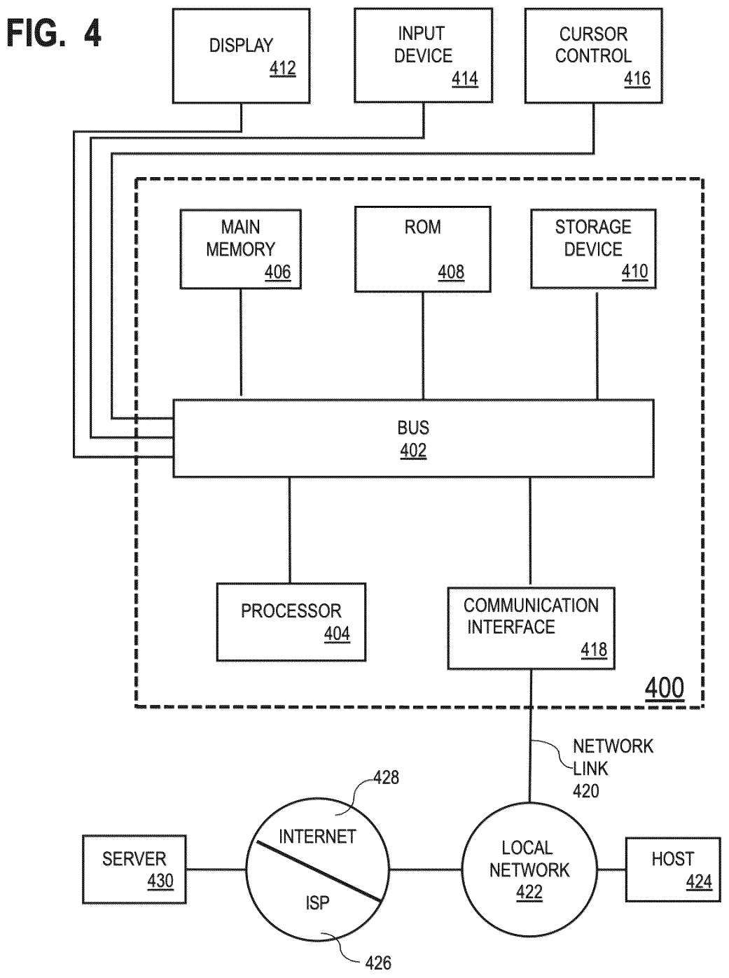

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing first attribute data associated with a first electronic document including data of an unknown content type;
applying a machine learning model to the first attribute data, wherein the machine learning model is trained to classify the first electronic document based the first attribute data and feature sets for a first set of document classes;
responsive to applying the machine learning model, determining the first electronic document corresponds to a first document class;
mapping the first document class, determined for the first electronic document using the machine learning model, to a first document layout for the first electronic document;
identifying first content type associated with the first document layout;
extracting, from the first electronic document, a first set of information corresponding to the first content type based on the first document layout; and
storing or transmitting the first set of information based on determining the first set of information corresponds to the first content type.

2. The one or more non-transitory computer readable media of claim 1, wherein the operations further comprise:
identifying a location of the first set of information within the first electronic document based on location information for the first content type indicated by the first document layout.

3. The one or more non-transitory computer readable media of claim 1, wherein identifying the first content type comprises identifying particular form fields of the first electronic document based on the first document layout,
wherein extracting the first set of information comprises extracting particular form field values from the particular form fields, and
wherein storing the first set of information comprises storing the particular form field values to update an entity database for managing form information from a plurality of electronic documents.

4. The one or more non-transitory computer readable media of claim 1, wherein the operations further comprise:
accessing second attribute data associated with a second electronic document;
applying the machine learning model to the second attribute data to classify the second electronic document;
responsive to applying the machine learning model, determining the second electronic document corresponds to a second document class;
mapping the second document class, determined for the second electronic document using the machine learning model, to a second document layout for the second electronic document;
identifying the first content type associated with the second document layout; and
extracting, from the second electronic document, a second set of information corresponding to the first content type based on the second document layout,
wherein the first set of information and the second set of information are a same information type.

5. The one or more non-transitory computer readable media of claim 1, accessing second attribute data associated with a second electronic document, wherein the second electronic document includes at least one of (a) different document dimensions and (b) a different orientation than the first electronic document;
applying the machine learning model to the second attribute data to classify the second electronic document;
responsive to applying the machine learning model, determining the second electronic document corresponds to the first document class;
mapping the first document class, determined for the second electronic document using the machine learning model, to the first document layout for the second electronic document; and
extracting, from the second electronic document, a second set of information corresponding to the first content type based on the first document layout.

6. The one or more non-transitory computer readable media of claim 5, wherein the machine learning model determines the second electronic document corresponds to the first document class based at least on a vector similarity between the second electronic document and the first document class.

7. The one or more non-transitory computer readable media of claim 1, wherein the operations further comprise:
receiving a request for first content of the first content type;
responsive to receiving the request:
identifying the first document layout, corresponding to the first document class, as including one or more elements for storing content of the first content type;
based on determining the first electronic document is of the first document class:
accessing the first content, stored in the first electronic document; and
transmitting, storing, and/or presenting the first content.

8. The one or more non-transitory computer readable media of claim 1, wherein the operations further comprise:
determining a first element of the first document layout corresponds to a first content type, wherein the first set of information is extracted from the first element of the first electronic document;
determining the first set of information is not of the first content type; and
responsive to determining the first set of information is not of the first content type:
classifying the first electronic document as a new document class not included among the first set of document classes;
determining a first feature set corresponding to the new document class;
adding the new document class to the first set of document classes to generate a second set of document classes; and
retraining the machine learning model on a training dataset including the second set of document classes.

9. A method comprising:
accessing first attribute data associated with a first electronic document including data of an unknown content type;
applying a machine learning model to the first attribute data, wherein the machine learning model is trained to classify the first electronic document based the first attribute data and feature sets for a first set of document classes;
responsive to applying the machine learning model, determining the first electronic document corresponds to a first document class;
mapping the first document class, determined for the first electronic document using the machine learning model, to a first document layout for the first electronic document;
identifying first content type associated with the first document layout;
extracting, from the first electronic document, a first set of information corresponding to the first content type based on the first document layout; and
storing or transmitting the first set of information based on determining the first set of information corresponds to the first content type,
wherein the method is performed by at least one device including a hardware processor.

10. The method of claim 9, further comprising:
identifying a location of the first set of information within the first electronic document based on location information for the first content type indicated by the first document layout.

11. The method of claim 9, wherein identifying the first content type comprises identifying particular form fields of the first electronic document based on the first document layout,
wherein extracting the first set of information comprises extracting particular form field values from the particular form fields, and
wherein storing the first set of information comprises storing the particular form field values to update an entity database for managing form information from a plurality of electronic documents.

12. The method of claim 9, further comprising:
accessing second attribute data associated with a second electronic document;
applying the machine learning model to the second attribute data to classify the second electronic document;
responsive to applying the machine learning model, determining the second electronic document corresponds to a second document class;
mapping the second document class, determined for the second electronic document using the machine learning model, to a second document layout for the second electronic document;
identifying the first content type associated with the second document layout; and
extracting, from the second electronic document, a second set of information corresponding to the first content type based on the second document layout,
wherein the first set of information and the second set of information are a same information type.

13. The method of claim 9, accessing second attribute data associated with a second electronic document, wherein the second electronic document includes at least one of (a) different document dimensions and (b) a different orientation than the first electronic document;
applying the machine learning model to the second attribute data to classify the second electronic document;
responsive to applying the machine learning model, determining the second electronic document corresponds to the first document class;
mapping the first document class, determined for the second electronic document using the machine learning model, to the first document layout for the second electronic document; and
extracting, from the second electronic document, a second set of information corresponding to the first content type based on the first document layout.

14. The method of claim 13, wherein the machine learning model determines the second electronic document corresponds to the first document class based at least on a vector similarity between the second electronic document and the first document class.

15. The method of claim 9, further comprising:
receiving a request for first content of the first content type;
responsive to receiving the request:
identifying the first document layout, corresponding to the first document class, as including one or more elements for storing content of the first content type;
based on determining the first electronic document is of the first document class:
accessing the first content, stored in the first electronic document; and
transmitting, storing, and/or presenting the first content.

16. The method of claim 9, further comprising:
determining a first element of the first document layout corresponds to a first content type, wherein the first set of information is extracted from the first element of the first electronic document;
determining the first set of information is not of the first content type; and
responsive to determining the first set of information is not of the first content type:
classifying the first electronic document as a new document class not included among the first set of document classes;
determining a first feature set corresponding to the new document class;
adding the new document class to the first set of document classes to generate a second set of document classes; and
retraining the machine learning model on a training dataset including the second set of document classes.

17. A system comprising:
at least one device including a hardware processor;
the system being configured to perform operations comprising:
accessing first attribute data associated with a first electronic document including data of an unknown content type;
applying a machine learning model to the first attribute data, wherein the machine learning model is trained to classify the first electronic document based the first attribute data and feature sets for a first set of document classes;
responsive to applying the machine learning model, determining the first electronic document corresponds to a first document class;
mapping the first document class, determined for the first electronic document using the machine learning model, to a first document layout for the first electronic document;
identifying first content type associated with the first document layout;
extracting, from the first electronic document, a first set of information corresponding to the first content type based on the first document layout; and
storing or transmitting the first set of information based on determining the first set of information corresponds to the first content type.

18. The system of claim 17, wherein the operations further comprise:
identifying a location of the first set of information within the first electronic document based on location information for the first content type indicated by the first document layout.

19. The system of claim 17, wherein identifying the first content type comprises identifying particular form fields of the first electronic document based on the first document layout,
wherein extracting the first set of information comprises extracting particular form field values from the particular form fields, and
wherein storing the first set of information comprises storing the particular form field values to update an entity database for managing form information from a plurality of electronic documents.

20. The system of claim 17, wherein the operations further comprise:
accessing second attribute data associated with a second electronic document;
applying the machine learning model to the second attribute data to classify the second electronic document;
responsive to applying the machine learning model, determining the second electronic document corresponds to a second document class;
mapping the second document class, determined for the second electronic document using the machine learning model, to a second document layout for the second electronic document;
identifying the first content type associated with the second document layout; and
extracting, from the second electronic document, a second set of information corresponding to the first content type based on the second document layout,
wherein the first set of information and the second set of information are a same information type.
